(19) United States
(12) Patent Application Publication
(10) Pub. No.: US 2003/0074669 A1
(43) Pub. Date: Apr. 17, 2003

(54) Data transmitting method and apparatus, and data receiving method and apparatus

(76) Inventors: Toshiharu Kobayashi, Tokyo (JP); Hiroki Matsuyama, Chiba (JP)

Correspondence Address: FROMMER LAWRENCE & HAUG, 745 FIFTH AVENUE- 10TH FL., NEW YORK, NY, 10151, US

(21) Appl. No.: 10/246,221

(22) Filed: Sep. 18, 2002

(30) Foreign Application Priority Data
Sep. 20, 2001 (JP) 2001-287093

(51) Int. Cl. H04N 7/173

(52) U.S. Cl. 725/95; 725/93

(57) ABSTRACT

In on-demand data transmission by performing packet data transmission/reception, encoded data is divided into a plurality of data segments, and a plurality of section packet data are formed. The plurality of section packet data are coded by performing a specific coding process on each of the plurality of data segments, and the plurality of section packet data are reformed into the data segments by performing a specific decoding process. The plurality of section packet data are then stored in a data memory. Each of the plurality of section packet data is repeatedly retrieved from the data memory, and the resulting sequences of section packet data are then sequentially transmitted on the corresponding data transmission channels, thus achieving multi-channel parallel data transmission.

### BACKGROUND OF THE INVENTION

1. Field of the Invention

The present invention relates to a data transmitting method and apparatus for dividing information data such as on-demand broadcast signal data into a plurality of data segments and for transmitting the resulting data segments on corresponding data transmission channels. The present invention further relates to a data receiving method and apparatus for receiving data transmitted according to the data transmitting method or transmitted by the data transmitting apparatus.

2. Description of the Related Art

In so-called on-demand broadcasts, such as television broadcasts, for broadcasting content such as movies or recorded images and audio, recipients are able to receive desired content on demand. With the significant advancement of digital technology both in hardware and software, and with a variety of content broadcasted, such on-demand broadcasts are expected to become widespread.

In on-demand data transmission such as on-demand broadcasting, information data indicating content to be transmitted is encoded using a predetermined coding process. For transmission of the encoded data, generally, there are two methods for dividing the data, and there is a specific method for data transmission.

The two data dividing methods are an equal dividing method and an unequal dividing method. In the equal dividing method, encoded data indicating various content is divided into a plurality of data segments having an equal time length. In the unequal dividing method, encoded data indicating various content is divided into a plurality of data segments having incremental time lengths. The specific method for data transmission includes the steps of dividing encoded data indicating various content into a plurality of data segments, individually coding the plurality of data segments according to a specific coding process to form a plurality of continuous packet data, and sequentially transmitting the plurality of continuous packet data.

FIG. 10 is a time chart indicating the concept of on-demand data transmission using the equal dividing method. In this on-demand data transmission, encoded data indicating predetermined content to be transmitted is divided into p data segments DS1 to DSp having an equal time length, where p denotes a positive integer of more than one.

The resulting data segment DS1 is converted into a continuous packet data DLT1 having a continuous packet stream by performing a specific coding process on the data segment DS1. The specific coding process may be implemented by, for example, a coding process (hereinafter referred to as an “LT coding process”) in which a packet stream having substantially infinite continuity is formed based on the data segment DS1 so that a portion (hereinafter referred to as “predetermined data portion”) of the packet stream which has the amount of data, for example, corresponding to about 105% of the data segment DS1 is decoded according to a specific decoding process to reproduce the original data segment DS1. The continuous packet data DLT1 is then continuously transmitted on a data transmission channel CH1.

Likewise, the resultant data segments DS2 to DSp are converted into continuous packet data DLT2 to DLTP each having a continuous packet stream by performing a specific coding process, for example, called the LT coding process, on each of the data segments DS2 to DSp. The packet data sequences DLT2 to DLTp are continuously transmitted on data transmission channels CH2 to CHp, respectively.

The continuous packet data DLT1 to DLTp transmitted on the corresponding data transmission channels (the data transmission channels CH1 to CHp) in this way form p-channel transmission data, achieving multi-channel parallel data transmission. A recipient in turn receives, at any time, the predetermined data portions of the continuous packet data DLT1 to DLTp transmitted as the p-channel transmission data to form the data segments DS1 to DSp based on the received predetermined data portions of the continuous packet data DLT1 to DLTp. Then, the recipient sequentially sends the data segments DS1 to DSp to reproduce the encoded data indicating the original content.

FIG. 11 is a time chart indicating the concept of on-demand data transmission using the unequal dividing method. In this on-demand data transmission, encoded data indicating predetermined content to be transmitted is divided into q data segments DS1 to DSq having incremental time lengths, where q denotes a positive integer of more than one.

The resulting data segment DS1 having the shortest time length is converted into continuous packet data DLT1 having a continuous packet stream by performing a specific coding process, for example, called the LT coding process, on the data segment DS1. The continuous packet data DLT1 is then continuously transmitted on a data transmission channel CH1.

Likewise, the resultant data segments DS2 to DSq having incremental time lengths that are longer than the time length of the data segment DS1 are converted into continuous packet data DLT2 to DLTq each having a continuous packet stream by performing a specific coding process, for example, called the LT coding process, on each of the data segments DS2 to DSq. The continuous packet data DLT2 to DLTq are continuously transmitted on data transmission channels CH2 to CHq, respectively.

The continuous packet data DLT1 to DLTq transmitted on the corresponding data transmission channels (the data transmission channels CH1 to CHq) in this way form q-channel transmission data, achieving multi-channel parallel data transmission. A recipient in turn receives, at any time, the predetermined data portions of the continuous packet data DLT1 to DLTq transmitted as the q-channel transmission data to form the data segments DS1 to DSq based on the received predetermined data portions of the continuous packet data DLT1 to DLTq. Then, the recipient sequentially sends the data segments DS1 to DSq to reproduce the encoded data indicating the original content.

In the on-demand data transmission shown in FIG. 10 or 11, when the data segments DS1 to DSp or DS1 to DSq are converted into the continuous packet data DLT1 to DLTp or DLT1 to DLTq, respectively, for multi-channel parallel data transmission, it is necessary to individually perform the LT coding process on the data segments DS1 to DSp or DS1 to DSq in a consecutive manner for a period from the beginning to end of the transmission period of the continuous packet data DLT1 to DLTp or DLT1 to DLTq in order to form the continuous packet data DLT1 to DLTp or DLT1 to DLTq. In other words, for transmission, the continuous packet data DLT1 to DLTp or DLT1 to DLTq should be generated in turn by individually performing the LT coding process on the data segments DS1 to DSp or DS1 to DSq in a consecutive manner.

Such an LT coding process in which the continuous packet data DLT1 to DLTp or DLT1 to DLTq are generated may be continuously executed by a data processor having an encoder which is controlled by, for example, a microcomputer. Performing the LT coding process in a continuous manner imposes significant load on the microcomputer, encoder, etc., in the data processor that continuously executes the LT coding process. If significant load is placed on the microcomputer, encoder, etc., in the data processor, the data processing speed is reduced, leading to inconvenience in that the data processor cannot provide fast and efficient data processing.

### SUMMARY OF THE INVENTION

Accordingly, it is an object of the present invention to provide a data transmitting method and apparatus in which information data indicating predetermined content to be transmitted can be converted into transmission packet data with reduced load on a data processor for on-demand transmission by packet data transmission/reception. It is another object of the present invention to provide a data receiving method and apparatus for receiving packet data transmitted according to the data transmitting method or transmitted by the data transmitting apparatus.

One of the foregoing objects is achieved by an aspect of the present invention through the provision of a data transmitting method for transmitting data on a plurality of data transmission channels in parallel. The method includes the steps of dividing information data in order into a plurality of data segments, each segment having a predetermined time length; forming a plurality of section packet data, wherein the plurality of section packet data are coded by performing a specific coding process on the plurality of data segments and the plurality of section packet data are reformed into the data segments by performing a specific decoding process; storing the plurality of section packet data in a memory; retrieving the plurality of section packet data stored in the memory; and sequentially transmitting the plurality of section packet data on the data transmission channels.

One of the foregoing objects is achieved by another aspect of the present invention through the provision of a data transmitting apparatus for transmitting data on a plurality of data transmission channels in parallel. The apparatus includes a loading unit for loading information data in a memory; a dividing unit for dividing the information data loaded in the memory in order into a plurality of data segments, each segment having a predetermined time length; a forming unit for forming a plurality of section packet data and storing the plurality of section packet data in the memory, wherein the plurality of section packet data are formed by performing a specific coding process on the plurality of data segments, and the plurality of data segments are decoded by performing a specific decoding process on the plurality of section packet data; and a transmitting unit for retrieving the plurality of section packet data stored in the memory and sequentially transmitting the plurality of section packet data on the data transmission channels.

One of the foregoing objects is achieved by still another aspect of the present invention through the provision of a data receiving method for reforming information data. The method includes the steps of receiving a plurality of section packet data transmitted sequentially on a plurality of data transmission channels, wherein the plurality of section packet data are formed by performing a specific coding process on a plurality of data segments each having a predetermined time length and can be reformed into the data segments by performing a specific decoding process; performing the specific decoding process on the plurality of section packet data to form a plurality of data segments each data segment having the predetermined time length; and reproducing the information data.

One of the foregoing objects is achieved by still another aspect of the present invention through the provision of a data receiving apparatus for reforming information data. The apparatus includes a receiving unit for receiving a plurality of section packet data transmitted sequentially on a plurality of data transmission channels, wherein the plurality of section packet data are formed by performing a specific coding process on a plurality of data segments each having a predetermined time length and can be reformed into the plurality of data segments by performing a specific decoding process; a decoding unit for performing the specific decoding process on the plurality of section packet data to form a plurality of data segments each data segment having the predetermined time length; and a reproducing unit for reproducing the information data.

In the data transmitting method and apparatus according to the present invention, therefore, information data is divided in order into a plurality of data segments each segment having a predetermined time length, and the plurality of data segments are converted into packet data, which are then sequentially transmitted on the corresponding transmission channels for multi-channel parallel data transmission. The plurality of data segments are converted into packet data by performing a specific coding process on the data segments. A plurality of section packet data are formed, and the plurality of section packet data are reformed into the data segments by performing a specific decoding process. The plurality of section packet data are then stored in a memory. Each of the plurality of section packet data stored in the memory is repeatedly retrieved, and the retrieved section packet data are organized in a sequential manner.

In multi-channel parallel data transmission, therefore, it is no longer necessary to continuously perform a specific coding process on each of a plurality of data segments in order to generate in turn a plurality of transmission packet data. Instead, it is only required to repeatedly retrieve each of a plurality of section packet data from the memory and to organize the retrieved section packet data in a sequential manner. Therefore, load placed on a data processor for forming a plurality of transmission packet data can be effectively reduced.

Furthermore, in the data receiving method and apparatus according to the present invention, a plurality of section packet data which are sequentially transmitted by the data transmitting apparatus which implements the data transmitting method according to the present invention are received. The plurality of received section packet data are decoded according to a specific decoding process to form in turn a plurality of data segments each having a predetermined time length. Then, the resulting data segments are sequentially sent to reproduce the original information data.

### BRIEF DESCRIPTION OF THE DRAWINGS

FIG. 1 is a block diagram of a data transmitting apparatus that implements a data transmitting method according to the present invention;

FIG. 2 is a time chart showing the operation of the data transmitting apparatus shown in FIG. 1;

FIG. 3 is a time chart showing the operation of the data transmitting apparatus shown in FIG. 1;

FIG. 4 is a flowchart showing a program executed for operation control by a CPU of the data transmitting apparatus shown in FIG. 1;

FIG. 5 is a flowchart of a program executed for operation control by the CPU of the data transmitting apparatus shown in FIG. 1;

FIG. 6 is a block diagram of a data receiving apparatus that implements a data receiving method according to the present invention;

FIG. 7 is a time chart showing the operation of the data receiving apparatus shown in FIG. 6;

FIG. 8 is a time chart showing the operation of the data receiving apparatus shown in FIG. 6;

FIG. 9 is a flowchart of a program executed for operation control by a CPU of the data receiving apparatus shown in FIG. 6;

FIG. 10 is a time chart showing on-demand data transmission using an equal dividing method; and

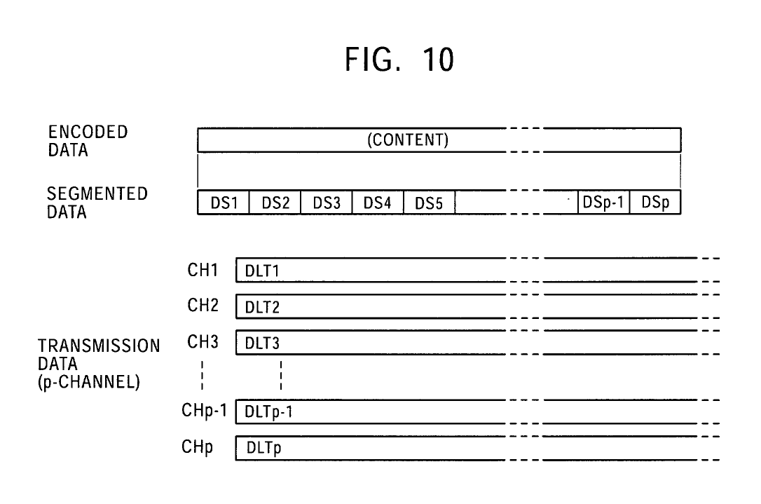

FIG. 11 is a time chart showing on-demand data transmission using an unequal dividing method.

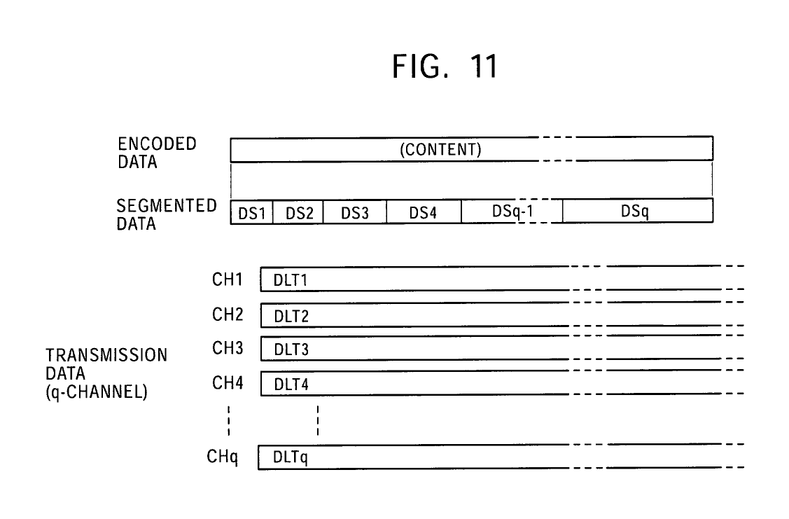

### DESCRIPTION OF THE PREFERRED EMBODIMENTS

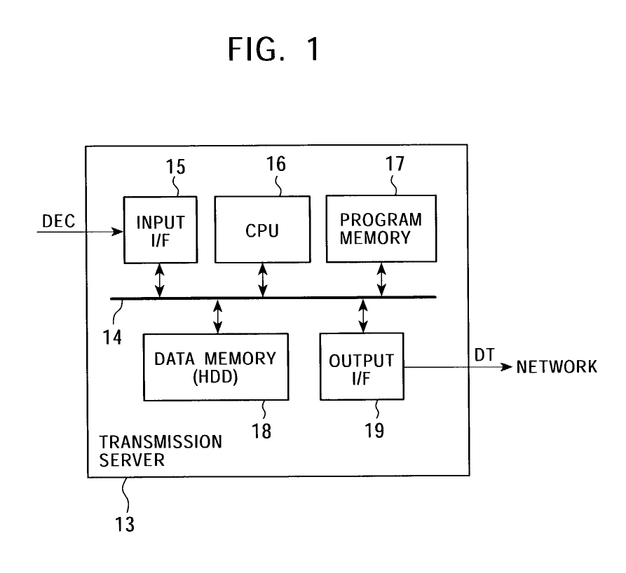

FIG. 1 is a block diagram of a data transmitting apparatus that implements a data transmitting method according to the present invention.

FIG. 1 shows a transmission server 13 for on-demand data transmission. In FIG. 1, for example, encoded data DEC indicating content such as movies or recorded images and audio, which has been encoded according to a specific compression coding process, is supplied as information data to the transmission server 13, where multi-channel transmission data DT is produced and is transmitted to a network (NETWORK).

The transmission server 13 shown in FIG. 1 has a basic configuration in which an input interface (input I/F) 15, a central processing unit (CPU) 16, a program memory 17, a data memory 18 implemented as a hard disk drive (HDD), and an output interface (output I/F) 19 are connected with a data bus 14.

In the transmission server 13, the encoded data DEC supplied through the input I/F 15 is sequentially processed under control of the CPU 16 according to an operation program stored in the program memory 17.

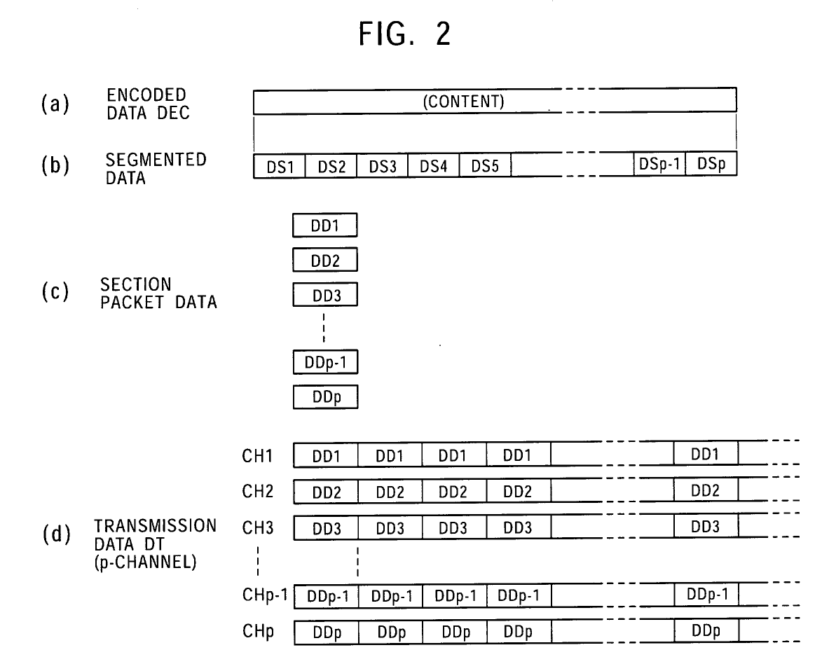

A first example for the processing on the encoded data DEC according to the operation program under control of the CPU 16 is described with reference to FIG. 2. First, the encoded data DEC shown in (a) is loaded in the data memory 18. The encoded data DEC loaded in the data memory 18 is then divided into p data segments DS1 to DSp, as shown in (b). Each of the data segments DS1 to DSp has an equal time length that is set in advance.

The resulting data segment DS1 is coded according to a specific coding process to generate packet data having a packet stream based on the data segment DS1. Specifically, the data segment DS1 is converted into packet data having a packet stream by performing a specific coding process on the data segment DS1. The specific coding process may be implemented by, for example, an LT coding process, as previously described, in which a packet stream having substantially infinite continuity is formed based on the data segment DS1 so that a portion (hereinafter referred to as “predetermined data portion”) of the packet stream which has the amount of data, for example, corresponding to about 105% of the data segment DS1 is decoded according to a specific decoding process to reproduce the original data segment DS1. The LT coding process can overcome an error (packet loss) problem involved in data transmission.

Then, section packet data DD1 shown in (c) is extracted and stored in the data memory 18. The section packet data DD1 corresponds to the amount of data of the packet data generated in turn by performing the specific coding process on the data segment DS1, on which a specific decoding process is performed to reproduce the original data segment DS1.

Likewise, the resultant data segments DS2 to DSp are coded according to a specific coding process to generate packet data having packet streams based on the data segments DS2 to DSp, respectively. Specifically, each of the data segments DS2 to DSp is converted into packet data having a packet stream by performing a specific coding process on each of the data segments DS2 to DSp. The specific coding process may also be implemented by the above-described LT coding process.

Then, section packet data DD2 to DDp shown in (c) are extracted and are stored in the data memory 18. Each of the section packet data DD2 to DDp corresponds to the amount of data of the packet data generated in turn by performing the specific coding process on each of the data segments DS2 to DSp, on which a specific decoding process is performed to reproduce each of the original data segments DS2 to DSp.

The section packet data DD1 to DDp stored in the data memory 18 have a substantially constant time length as the data segments DS1 to DSp have an equal time length.

The section packet data DD1 stored in the data memory 18 is repeatedly retrieved from the data memory 18, and the retrieved section packet data DD1 are sequentially organized in the manner shown in (d). The sequence of section packet data DD1 is sent via the output I/F 19 to a network connected to the transmission server 13 so that the sequence of section packet data DD1 is transmitted on a data transmission channel CH1.

Likewise, each of the section packet data DD2 to DDp stored in the data memory 18 is repeatedly retrieved from the data memory 18, and the retrieved section packet data are sequentially organized in the manner shown in (d). The sequences of section packet data DD2 to DDp are sent via the output I/F 19 to the network connected to the transmission server 13 so that the sequences of section packet data DD2 to DDp are transmitted on data transmission channels CH2 to CHp, respectively.

Accordingly, each of the section packet data DD1 to DDp stored in the data memory 18 is repeatedly retrieved from the data memory 18, and the retrieved section packet data are organized in a sequential manner to form p-channel transmission data DT shown in (d). The transmission data DT is transmitted on the corresponding data transmission channels CH1 to CHp, achieving p-channel parallel data transmission.

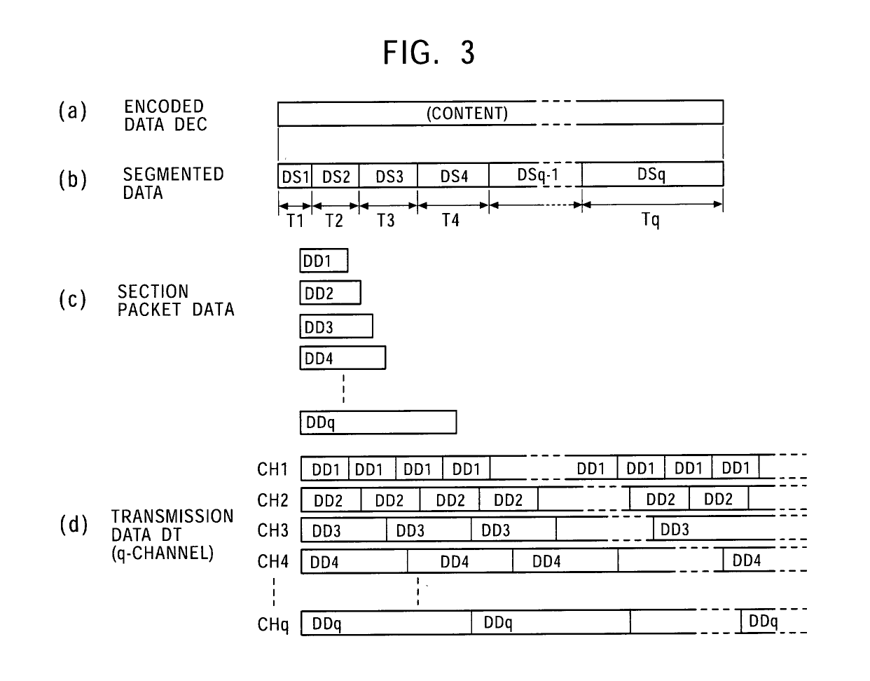

A second example for the processing on the encoded data DEC according to the operation program under control of the CPU 16 is now described with reference to FIG. 3. First, the encoded data DEC shown in (a) is loaded in the data memory 18. The encoded data DEC loaded in the data memory 18 is then divided into q data segments DS1 to DSq, as shown in (b).

The data segments DS1 to DSq are formed so that the initial data segment DS1 has a predetermined relatively short time length T1 and the data segments DS2 to DSq subsequent to the data segment DS1 have predetermined time lengths T2 to Tq, respectively, which gradually increase (incremental segment lengths), where T1<T2<T3<T4< . . . <Tq. In other words, each of the data segments DS1 to DSq has a predetermined time length, and the predetermined time lengths of the data segments DS1 to DSq gradually increase.

The data segment DS1 is coded according to a specific coding process to generate packet data having a packet stream based on the data segment DS1. Specifically, the data segment DS1 having the time length T1 is converted into packet data having a packet stream by performing the specific coding process on the data segment DS1. The specific coding process may be implemented by the above-described LT coding process.

Then, section packet data DD1 shown in (c) is extracted and stored in the data memory 18. The section packet data DD1 corresponds to the amount of data of the packet data generated in turn by performing the specific coding process on the data segment DS1, on which a specific decoding process is performed to reproduce the original data segment DS1. The section packet data DD1 has a time length in accordance with the data segment DS1 having the time length T1.

In a similar manner to the data segment DS1, the data segments DS2 to DSq are coded according to a specific coding process to generate packet data each having a packet stream based on each of the data segments DS2 to DSq. Specifically, the data segments DS2 to DSq having time lengths T2 to Tq, respectively, are converted into packet data each having a packet stream by performing a specific coding process on the data segments DS2 to DSq, respectively. The specific coding process may also be implemented by the above-described LT coding process.

Then, section packet data DD2 to DDq shown in (c) are extracted and stored in the data memory 18. Each of the section packet data DD2 to DDq corresponds to the amount of data of the packet data generated in turn by performing the specific coding process on each of the data segments DS2 to DSq, on which a specific decoding process is performed to reproduce each of the original data segments DS2 to DSq. The section packet data DD2 to DDq have time lengths in accordance with the data segments DS2 to DSq having the time lengths T2 to Tq, respectively.

Accordingly, the section packet data DD1 to DDq stored in the data memory 18 have incremental time lengths which increase from the section packet data DDI to the section packet data DDq as the data segments DS1 to DSq have incremental time lengths which increase from the data segments DS1 to DSq.

The section packet data DD1 stored in the data memory 18 is repeatedly retrieved from the data memory 18, and the retrieved section packet data DD1 are sequentially organized in the manner shown in (d). The sequence of section packet data DD1 is sent via the output I/F 19 to a network connected to the transmission server 13 so that the sequence of section packet data DD1 is transmitted on a data transmission channel CH1.

Likewise, each of the section packet data DD2 to DDq stored in the data memory 18 is repeatedly retrieved from the data memory 18, and the retrieved section packet data are sequentially organized in the manner shown in (d). The sequences of section packet data DD2 to DDq are sent via the output I/F 19 to the network connected to the transmission server 13 so that the sequences of section packet data DD2 to DDq are transmitted on data transmission channels CH2 to CHq, respectively.

Accordingly, each of the section packet data DD1 to DDq stored in the data memory 18 is repeatedly retrieved from the data memory 18, and the retrieved section packet data are organized in a sequential manner to form q-channel transmission data DT shown in (d). The transmission data DT is transmitted on the corresponding data transmission channels CH1 to CHq, achieving q-channel parallel data transmission.

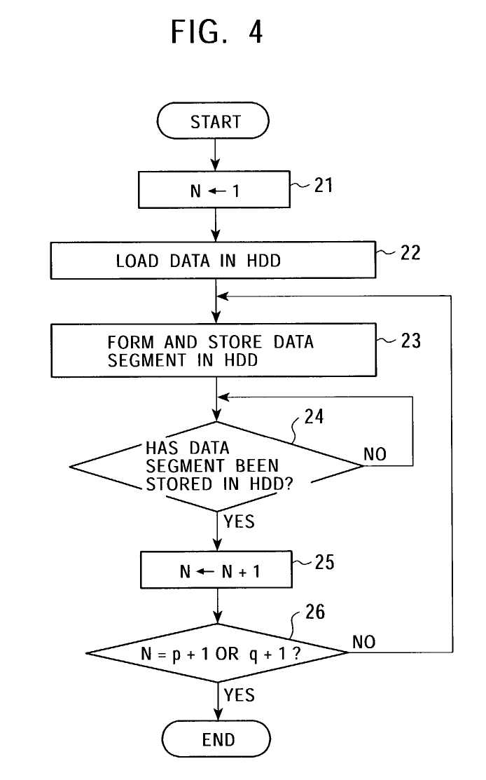

FIG. 4 is a flowchart showing an example operation program executed by the CPU 16 to divide the encoded data DEC, which is information data, into the data segments DS1 to DSp or into the data segments DS1 to DSq. In the operation program shown in the flowchart in FIG. 4, first, in step 21, variable N is initialized as one.

In step 22, the encoded data DEC is loaded in the data memory (HDD) 18. In step 23, the N-th (Ns=N) data segment DSN is formed based on the encoded data DEC loaded in the data memory 18, and is stored in the data memory 18. Then, the program proceeds to step 24.

In step 24, it is determined whether or not the Ns=N data segment DSN has been stored in the data memory 18. If the data segment DSN has not been stored, the determination processing in step 24 is repeated. If the data segment DSN has been stored, the variable N increments by “1” in step 25, and the program proceeds to step 26. In step 26, it is determined whether or not the variable N reaches (p+1) or (q+1). If the variable N does not reach (p+1) or (q+1), the program returns to step 23 to repeat the processing of steps subsequent to step 23. If the variable N reaches (p+1) or (q+1), the program ends.

In step 23 of forming the Ns=N data segment DSN, either the data segments DS1 to DSp having a predetermined equal time length or the data segments DS1 to DSq having predetermined incremental time lengths are formed.

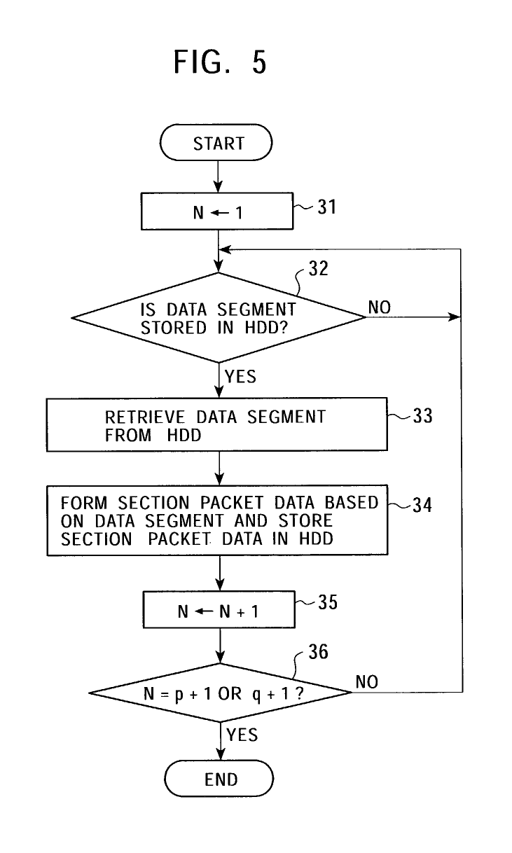

FIG. 5 is a flowchart showing an example operation program executed by the CPU 16 to form section packet data DD1 to DDp based on the data segments DS1 to DSp or to form section packet data DD1 to DDq based on the data segment DS1 to DSq, respectively, and to store the resulting section packet data in the data memory (HDD) 18. In the operation program shown in the flowchart in FIG. 5, first, in step 31, variable N is initialized as one.

In step 32, it is determined whether or not the Ns=N data segment DSN has been stored in the data memory 18. If the Ns=N data segment DSN has not been stored in the data memory 18, the determination processing in step 32 is repeated. If the Ns=N data segment DSN has been stored in the data memory 18, then, in step 33, the Ns=N data segment DSN is retrieved from the data memory 18. In step 34, section packet data DDN is formed based on the retrieved Ns=N data segment DSN, and the resulting section packet data DDN is stored in the data memory 18.

In step 35, the variable N increments by “1”, and the program proceeds to step 36. In step 36, it is determined whether or not the variable N reaches (p+1) or (q+1). If the variable N does not reach (p+1) or (q+1), the program returns to step 32 to repeat the processing of steps subsequent to step 32. If the variable N reaches (p+1) or (q+1), the program ends.

In step 34 where the section packet data DDN is formed based on the Ns=N data segment DSN and is stored in the data memory 18, either the section packet data DD1 to DDp having a substantially constant time length or the section packet data DD1 to DDq having incremental time lengths from the section packet data DD1 to DDq are formed and stored in the data memory 18.

Each of the section packet data DD1 to DDp or the section packet data DD1 to DDq stored in the data memory 18 is repeatedly retrieved from the data memory 18, and the retrieved section packet data are organized in a sequential manner to form p-channel or q-channel transmission data DT. The resulting p-channel or q-channel transmission data DT is then transmitted in parallel on the corresponding data transmission channels CH1 to CHp or the corresponding data transmission channels CH1 to CHq, achieving p-channel or q-channel parallel data transmission.

In the transmission server 13 shown in FIG. 1, therefore, it is no longer necessary to continuously perform a specific coding process on each of p or q data segments in order to generate in turn packet data forming p-channel or q-channel transmission data DT for p-channel or q-channel parallel data transmission. Instead, it is only required to repeatedly retrieve p or q section packet data from the data memory 18 and to organize the retrieved packet data in a sequential manner. Therefore, load placed on the CPU 16 and the data memory 18 can be effectively reduced to form the p-channel or q-channel transmission data DT.

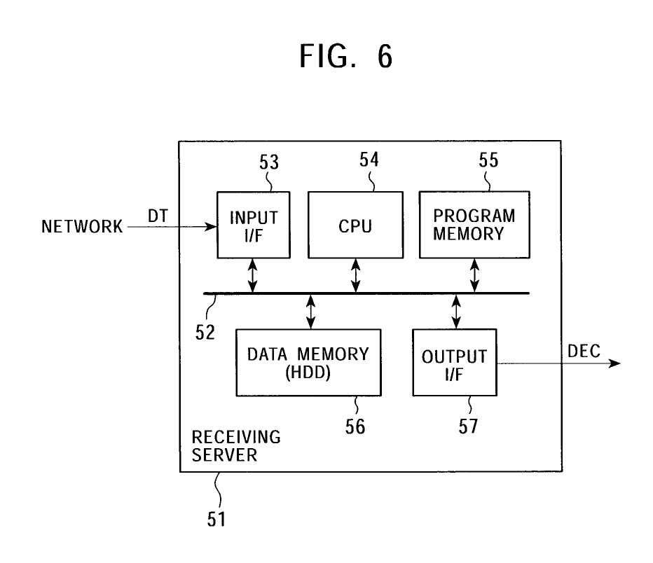

FIG. 6 is a block diagram of a data receiving apparatus that implements a data receiving method according to the present invention.

FIG. 6 shows a receiving server 51 for receiving transmission data DT transmitted by the data transmitting apparatus (transmission server 13) shown in FIG. 1 over the network (NETWORK).

The receiving server 51 shown in FIG. 6 has a basic configuration in which an input interface (input I/F) 53, a central processing unit (CPU) 54, a program memory 55, a data memory 56 implemented as a hard disk drive (HDD), and an output interface (output I/F) 57 are connected with a data bus 52.

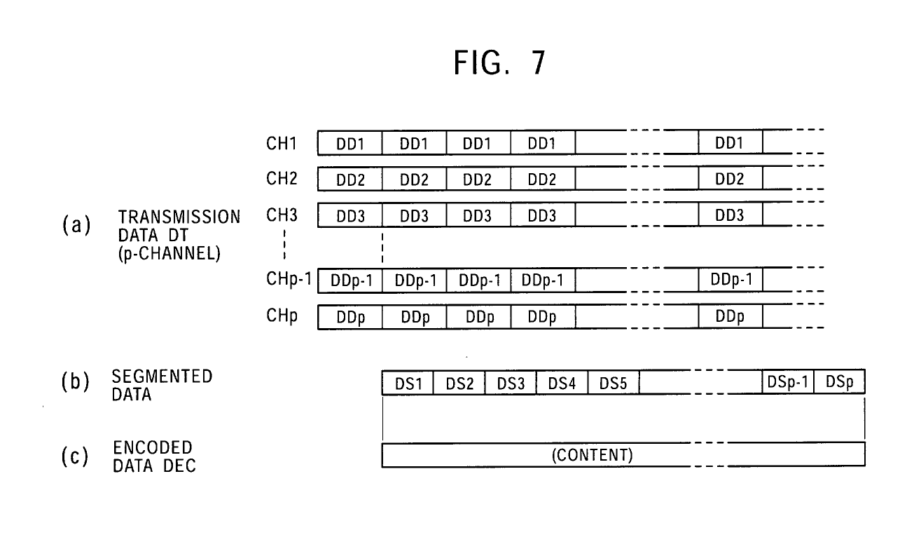

The case where the transmission data DT transmitted by the transmission server 13 shown in FIG. 1 comprises p-channel packet data having section packet data sequences DD1 to DDp shown in FIG. 2 is now described with reference to FIG. 7. In the receiving server 51, the p-channel packet data which is supplied through the input I/F 53 and which has section packet data sequences DD1 to DDp transmitted on the data transmission channels CH1 to CHp, respectively, as shown in (a), is processed in order under control of the CPU 54 according to an operation program stored in the program memory 55.

First, the p-channel packet data which has section packet data sequences DD1 to DDp transmitted on the data transmission channels CH1 to CHp, respectively, is received. The section packet data DD1 to DDp are extracted from the received p-channel packet data, and are then loaded in the data memory (HDD) 56.

Then, the section packet data DD1 loaded in the data memory 56 is retrieved from the data memory 56, and the packet stream of the section packet data DD1, which has been coded according to a specific coding process, is decoded according to a specific decoding process to obtain the data segment DS1. Subsequently, the section packet data DD2 to DDp loaded in the data memory 56 are retrieved from the data memory 56, and the packet streams of the section packet data DD2 to DDp, which have been coded according to a specific coding process, are decoded according to a specific decoding process to sequentially obtain the data segments DS2 to DSp in order.

Thus, segmented data having a concatenation of data segments DS1 to DSp each having an equal time length is obtained, as shown in (b). The original encoded data DEC shown in (c) is reproduced from the segmented data, and is then transmitted via the output I/F 57.

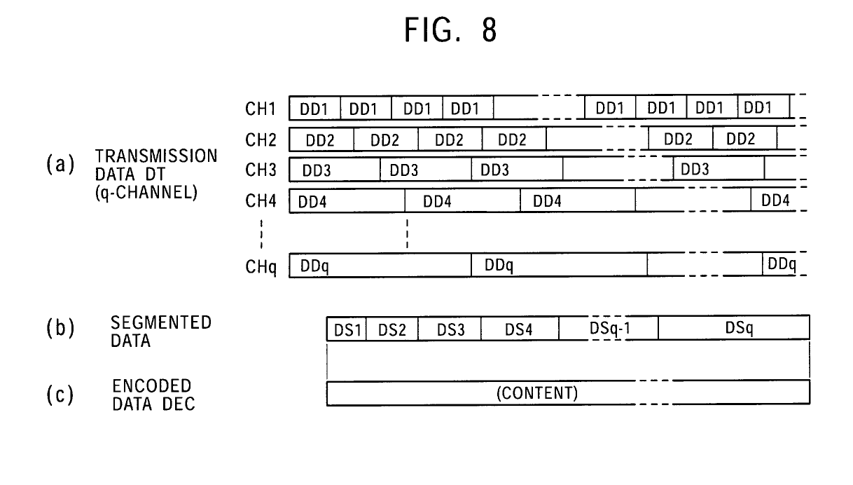

The case where the transmission data DT transmitted by the transmission server 13 shown in FIG. 1 comprises a q-channel packet data having section packet data sequences DD1 to DDq shown in FIG. 3 is now described with reference to FIG. 8. In the receiving server 51, the q-channel packet data which is supplied through the input I/F 53 and which has section packet data sequences DD1 to DDq transmitted on the data transmission channels CHI to CHq, respectively, as shown in (a), is processed in order under control of the CPU 54 according to an operation program stored in the program memory 55.

First, the q-channel packet data which has section packet data sequences DD1 to DDq transmitted on the data transmission channels CH1 to CHq, respectively, is received. The section packet data DD1 to DDq are extracted from the received q-channel packet data, and are then loaded in the data memory (HDD) 56.

Then, the section packet data DD1 loaded in the data memory 56 is retrieved from the data memory 56, and the packet stream of the section packet data DD1, which has been coded according to a specific coding process, is decoded according to a specific decoding process to obtain the data segment DS1. Subsequently, the section packet data DD2 to DDq loaded in the data memory 56 are retrieved from the data memory 56, and the packet streams of the section packet data DD2 to DDq, which have been coded according to a specific coding process, are decoded according to a specific decoding process to sequentially obtain the data segments DS2 to DSq in order.

Thus, segmented data having a concatenation of data segments DS1 to DSq having incremental time lengths from the data segments DS1 to DSq is obtained, as shown in (b). The original encoded data DEC shown in (c) is reproduced from the segmented data, and is then transmitted via the output I/F 57.

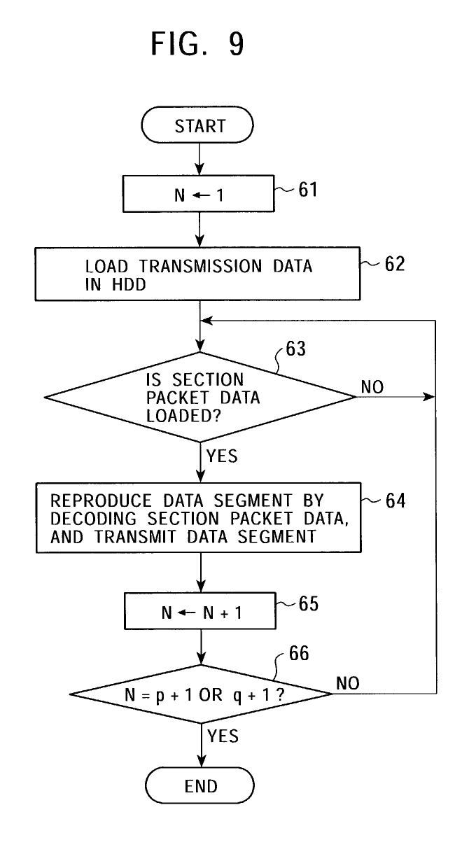

FIG. 9 is a flowchart showing an example operation program executed by the CPU 54 to receive the p-channel or q-channel transmission data DT, to load the section packet data DD1 to DDp or the section packet data DD1 to DDq in the data memory (HDD) 56, and to convert the section packet data DD1 to DDp or the section packet data DD1 to DDq into the data segments DS1 to DSp or the data segments DS1 to DSq to reproduce the encoded data DEC.

In the operation program shown in the flowchart in FIG. 9, first, in step 61, variable N is initialized as one.

In step 62, the transmission data DT formed of the p-channel packet data having section packet data sequences DD1 to DDP which are transmitted on the data transmission channels CH1 to CHp, respectively, or the q-channel packet data having section packet data sequences DD1 to DDq which are transmitted on the data transmission channels CH1 to CHq, respectively, is received. Then, the section packet data DD1 to DDp are extracted from the p-channel packet data or the section packet data DD1 to DDq are extracted from the q-channel packet data, and are loaded in the data memory 56.

In step 63, it is determined whether or not the Ns=N section packet data DDN has been loaded in the data memory 56. If the section packet data DDN has not been loaded in the data memory 56, the determination processing in step 63 is repeated. If the section packet data DDN has been loaded in the data memory 56, then, in step 64, the section packet data DDN is retrieved from the data memory 56. Then, the packet stream data of the section packet data DDN, which has been coded according to a specific coding process, is decoded according to a specific decoding process to reproduce the data segment DSN from the section packet data DDN. The resulting data segment DSN is then sent.

In step 65, the variable N increments by “1”, and the program proceeds to step 66. In step 66, it is determined whether or not the variable N reaches (p+1) or (q+1). If the variable N does not reach (p+1) or (q+1), the program returns to step 63 to repeat the processing of steps subsequent to step 63. If the variable N reaches (p+1) or (q+1), the program ends.

What is claimed is:

1. A data transmitting method for transmitting data on a plurality of data transmission channels in parallel, the method comprising the steps of:
dividing information data in order into a plurality of data segments, each segment having a predetermined time length;
forming a plurality of section packet data, wherein said plurality of section packet data are coded by performing a specific coding process on said plurality of data segments and said plurality of section packet data are reformed into said data segments by performing a specific decoding process;
storing said plurality of section packet data in a memory;
retrieving said plurality of section packet data stored in said memory; and
sequentially transmitting said plurality of section packet data on the data transmission channels.

2. A data transmitting method according to claim 1, wherein the specific coding process performed on said plurality of data segments is a coding process in which a packet stream having apparently infinite continuity is formed based on each of said plurality of data segments.

3. A data transmitting method according to claim 1, wherein the predetermined time lengths of said plurality of data segments increase for every data segment.

4. A data transmitting apparatus for transmitting data on a plurality of data transmission channels in parallel, the apparatus comprising:
loading means for loading information data in a memory;
dividing means for dividing said information data loaded in said memory in order into a plurality of data segments, each segment having a predetermined time length;
forming means for forming a plurality of section packet data and storing said plurality of section packet data in said memory, wherein said plurality of section packet data are formed by performing a specific coding process on said plurality of data segments, and said plurality of data segments are decoded by performing a specific decoding process on said plurality of section packet data; and
transmitting means for retrieving said plurality of section packet data stored in said memory and sequentially transmitting said plurality of section packet data on the data transmission channels.

5. A data transmitting apparatus according to claim 4, wherein the specific coding process performed on said plurality of data segments is a coding process in which a packet stream having apparently infinite continuity is formed based on each of said plurality of data segments when said plurality of section packet data are formed by said forming means.

6. A data transmitting apparatus according to claim 4, wherein the predetermined time lengths of said plurality of data segments increase for every data segment.

7. A data receiving method for reforming information data, the method comprising the steps of:
receiving a plurality of section packet data transmitted sequentially on a plurality of data transmission channels, wherein said plurality of section packet data are formed by performing a specific coding process on a plurality of data segments each having a predetermined time length and can be reformed into said data segments by performing a specific decoding process;
performing said specific decoding process on said plurality of section packet data to form a plurality of data segments, wherein each data segment has said predetermined time length; and
reproducing said information data.

8. A data receiving method according to claim 7, further comprising the steps of:
storing the plurality of received section packet data in a memory; and
retrieving said plurality of section packet data stored in said memory for decoding according to said specific decoding process.

9. A data receiving apparatus for reforming information data, the apparatus comprising:
receiving means for receiving a plurality of section packet data transmitted sequentially on a plurality of data transmission channels, wherein said plurality of section packet data are formed by performing a specific coding process on a plurality of data segments each having a predetermined time length and can be reformed into said plurality of data segments by performing a specific decoding process;
decoding means for performing said specific decoding process on said plurality of section packet data to form a plurality of data segments, wherein each data segment has said predetermined time length; and
reproducing means for reproducing said information data.
